(19) United States
(12) Patent Application Publication
(10) Pub. No.: US 2009/0160937 A1
(43) Pub. Date: Jun. 25, 2009

(54) CAMERA CONTROL METHOD FOR VEHICLE ENTRAMCE CONTROL SYSTEM

(76) Inventor: Seung Nam Son, Gangnam-gu (KR)

Correspondence Address: STETINA BRUNDA GARRED & BRUCKER, 75 ENTERPRISE, SUITE 250, ALISO VIEJO, CA, 92656, US

(21) Appl. No.: 12/274,295

(22) Filed: Nov. 19, 2008

(30) Foreign Application Priority Data
Dec. 21, 2007 (KR) 1020070134775

(51) Int. Cl. H04N 7/18

(52) U.S. Cl. 348/148; 348/E07.085

(57) ABSTRACT

This development is about the camera control method for a vehicle entrance control system. In detail, it is about the applying variable exposure time and gain level per image frames that are captured through a CCTV camera of vehicle entrance control system. The entire control is done through 4 steps. The first step is to calculate the average value of image brightness and write the multiple parameters of exposure time and gain level that match with the calculated average brightness value in the lookup table to a camera control register. The second step is to compare average brightness value with the threshold of strobe operation and compare acquired exposure time and gain level parameters with the preset maximum limitations. The third step is to turn on strobe if the acquired exposure time and gain level parameters are higher than preset maximum limitation and average brightness value is lower than strobe operation threshold. The fourth step is to adjust exposure time and gain level if the acquired exposure time and gain level parameters are lower than preset maximum limitation and average brightness value is higher than strobe operation threshold. This development is to maintain a certain brightness level of images by controlling exposure time and gain level on a camera and turning on and off a strobe, which is proven the most adequate brightness for license plate recognition.

### CROSS-REFERENCE TO RELATED APPLICATIONS

The present application claims priority to Korean Patent Application No. 10-2007-0134775 entitled CAMERA CONTROL METHOD FOR VEHICLE ENTRANCE CONTROL SYSTEM filed on Dec. 21, 2007.

### STATEMENT RE: FEDERALLY SPONSORED RESEARCH/DEVELOPMENT

Not Applicable

### BACKGROUND

1. Technical Field

This development is about the camera control method for a vehicle entrance control system. In detail, it is about the applying variable exposure time and gain level per image frame that is captured through a CCTV camera of vehicle entrance control system.

2. Related Art

Generally, vehicle entrance control system is to allow or block a car from entering into a building or apartment complex by using license plate recognition or RF ID on a car. For a system that uses license plate recognition, the most important aspect is to capture a high quality and bright-enough image for successful recognition. In most cases, license plate recognition system uses a progressive-scan camera as image input device. A progressive-scan camera does not interlace two images in composing a full image. Interlacing method creates artifacts known as ‘mouse teeth’ or ‘tearing’, when the pixels in one frame do not line up with the pixels in the other, forming a jagged edge. Instead, a progressive-scan camera captures a full image at once, which provides a high quality image. By using a progressive camera, image quality issue can be addressed. However, brightness issue should be addressed even with a progressive-scan camera for better recognition. In real world, the brightness of surroundings keeps changing by time of a day (morning, afternoon and night) and weather conditions (sunny and cloudy). Especially with incoming traffic to the entrance that can cause continuous and instant change of brightness in the scenery, license plate recognition system can be easily disturbed and make errors in recognizing numbers. There are two methods to avoid those situations of capturing non-recognizable images; hardware-based control and software-based control. Hardware based method is to use motorized zoom lens that adjusts lens iris accordingly to the brightness change in the scenery. Software-based method is to control a camera with its internal control parameters of exposure time and gain level.

The exposure time adjusts the amount of sun lights coming into a camera and gain level adjusts the amount of data gaining during the conversion from analog data to digital data. In general, it is possible to get a brighter image by increasing expose time (slow down exposure time) and gain level. On the other hand, longer exposure time and higher gain level can deteriorate image quality. During the night time, longer expose time can damage license plate image (poor quality) due to the reflection from an illuminator that is used to increase the brightness on the site. On the contrary (short expose time and lower gain level), camera may generate dark image with which the recognition system fails to read the numbers.

### Problem to Address

To address above problems, this development provides a method to control a camera by changing exposure time and gain level gradually for each image frame for a certain period of time, through which a camera generates and provides images of various brightness to vehicle entrance control system.

Another purpose of this development is to secure a control method of a camera that may control a camera accordingly to the time of a day (day or night), so that a camera may output optimized image frame to vehicle entrance control system.

### Solution

The method to resolve above problems has 4 steps.

The first step is to calculate the average value of image brightness and write the multiple parameters of exposure time and gain level that match with the calculated average brightness value in the lookup table to a camera control register. The second step is to compare average brightness value with the threshold of strobe operation and compare acquired exposure time and gain level parameters with the preset maximum limitations. The third step is to turn on strobe if the acquired exposure time and gain level parameters are higher than preset maximum limitation and average brightness value is lower than strobe operation threshold. The fourth step is to adjust exposure time and gain level if the acquired exposure time and gain level parameters are lower than preset maximum limitation and average brightness value is higher than strobe operation threshold.

### Effect

This development is to generate images of a certain level of brightness regardless time of a day (day or night) by adjusting exposure time and gain level of each frame, which may aid a camera to output proper images for better recognition.

### BRIEF SUMMARY

This development is about the camera control method for a vehicle entrance control system. In detail, it is about the applying variable exposure time and gain level per image frames that are captured through a CCTV camera of vehicle entrance control system.

The entire control is done through 4 steps. The first step is to calculate the average value of image brightness and write the multiple parameters of exposure time and gain level that match with the calculated average brightness value in the lookup table to a camera control register. The second step is to compare average brightness value with the threshold of strobe operation and compare acquired exposure time and gain level parameters with the preset maximum limitations. The third step is to turn on strobe if the acquired exposure time and gain level parameters are higher than preset maximum limitation and average brightness value is lower than strobe operation threshold. The fourth step is to adjust exposure time and gain level if the acquired exposure time and gain level parameters are lower than preset maximum limitation and average brightness value is higher than strobe operation threshold.

This development is to maintain a certain brightness level of images by controlling exposure time and gain level on a camera and turning on and off a strobe, which is proven the most adequate brightness for license plate recognition.

### BRIEF DESCRIPTION OF THE DRAWINGS

FIG. 1 is a block diagram of a progressive camera of the present invention;

FIG. 2 a flow chart of controlling a camera of the present invention;

FIG. 3 is the flow chart of controlling a camera with its exposure time parameter;

FIG. 4 is the flow chart of controlling a camera with its gain level parameter;

FIG. 5 is the flow chart of controlling ca camera during night time;

### DETAILED DESCRIPTION OF THE INVENTION

With referring to following figures, it describes how the development works in detail.

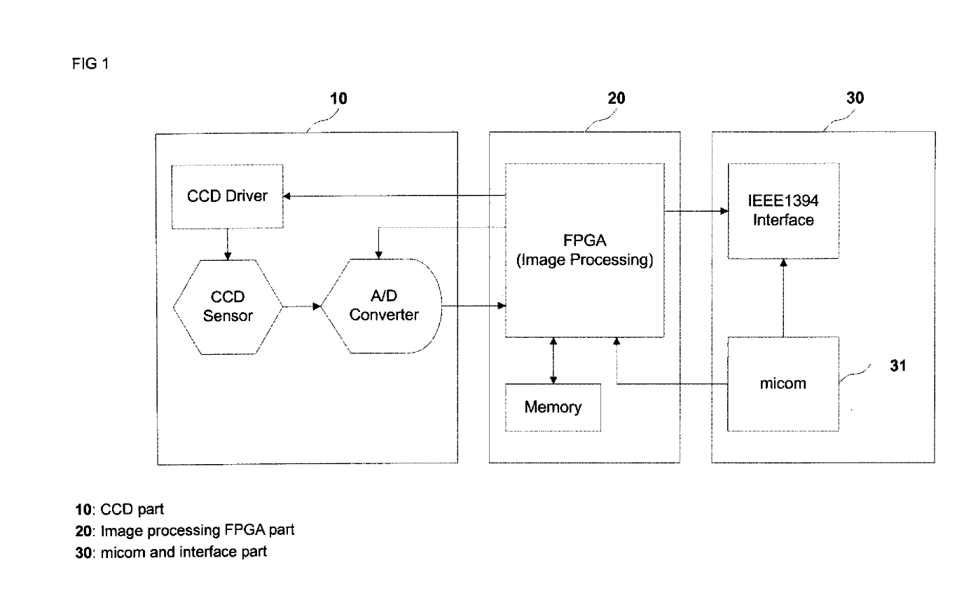

FIG. 1 is a block diagram of a camera. A progressive-scan CCTV camera functions as the block diagram.

FIG. 1 block diagram is of a progressive camera that captures images under progressive scanning method and outputs the captured images through IEEE1394 interface. FIG. 1 camera is composed of 3 major parts including CCD part (10), FPGA part (20), and micom control & interface part (30). CCD part (10) is to capture analog light signal and convert it into digital electric signal. This part has CCD (Charge Coupled Device) sensor, CCD driver, and A/D (Analog/Digital) converter. Once CCD driver runs CCD, CCD sensor converts light signal into electric signal and inputs electric signal to A/D converter. A/D converter converts analog signal into digital signal and outputs digital signal to next part. FPGA part (20) is to process digital signal into video signal under progressive scanning method. Through this part, the entire frame of an image is generated by deciding each detailed elements such as brightness, quality, color, etc. Micom control & interface part (30) is to control the entire components of a camera and outputs video to another device that is connected to the camera through the interface. micom (31) controls to read and write operational parameter on the camera register. Image output interface supports IEEE1394 and it has IEEE1394 link, physical layer and connector.

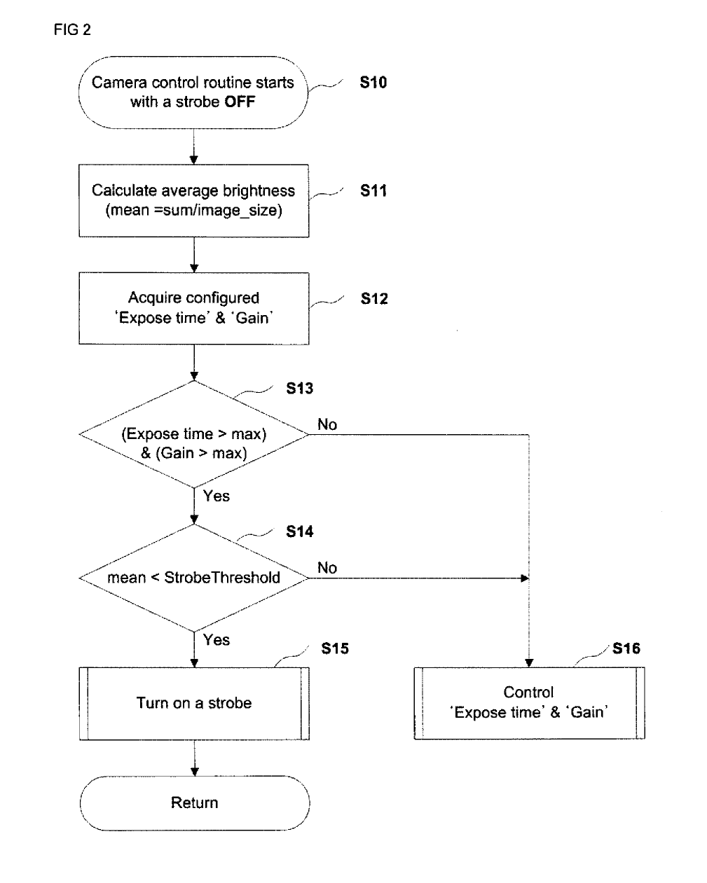

FIG. 2 a flow chart of controlling a camera of this development. First of all, parameters shall be fixed with which a camera is controlled. Table 1 is the examples of the control parameters.

TABLE 1
Camera control parameter

| | Default | | |
|---|---|---|---|
| Name | value | Description | Remark |
| DefaultGain | 28 | Default gain level value | In the system, |
| MaxGain | 60 | Maximum gain level value | parameters can be |
| MaxExp | 6000 | Maximum exposure time | changed through |
| | | value | its configuration |
| UpThreshold | 90 | Threshold of image brightness | command |
| | | to decrease exposure time | |
| Down- | 70 | Threshold of image | |
| Threshold | | brightness to | |
| | | increase exposure time | |
| Strobe- | 55 | Threshold of image | |
| Threshold | | brightness to turn | |
| | | on/off strobe | |
| NightExp- | 3000 | Expose time with a strove | |
| Time | | | |

At the stage of S10 in FIG. 2, it checks if a strobe is off. A strove is for night time operation. When it is confirmed, the process starts. At S11 stage, it calculates the average brightness of the current image frame. The average brightness is calculated by dividing the entire brightness value with the total number of entire pixels of the image. At S12 stage, the system gets currently set expose time and gain level parameters from a camera. At S13 stage, the system compares the acquired expose time and gain level with MaxExp and MaxGain parameters that are pre-defined in Table 1. If the acquired actual parameters of exposure time and gain level are not bigger than MaxExp and MaxGain parameters, the system adjusts the exposure time and gain level on a camera (S16). If the acquired actual parameters of exposure time and gain level are bigger than MaxExp and MaxGain parameters, the system compares the current image frame's average brightness value with StrobeThreshold (S14). If the average brightness value is bigger than StrobeThreshold, the system adjusts the exposure time and gain level on a camera (S16). If the average brightness value is not bigger than StrobeThreshold, the system turns on a strobe (S15). In other words, the smaller average brightness value than StrobeThreshold means that it is a night time. Thus it is necessary to turn on a strobe.

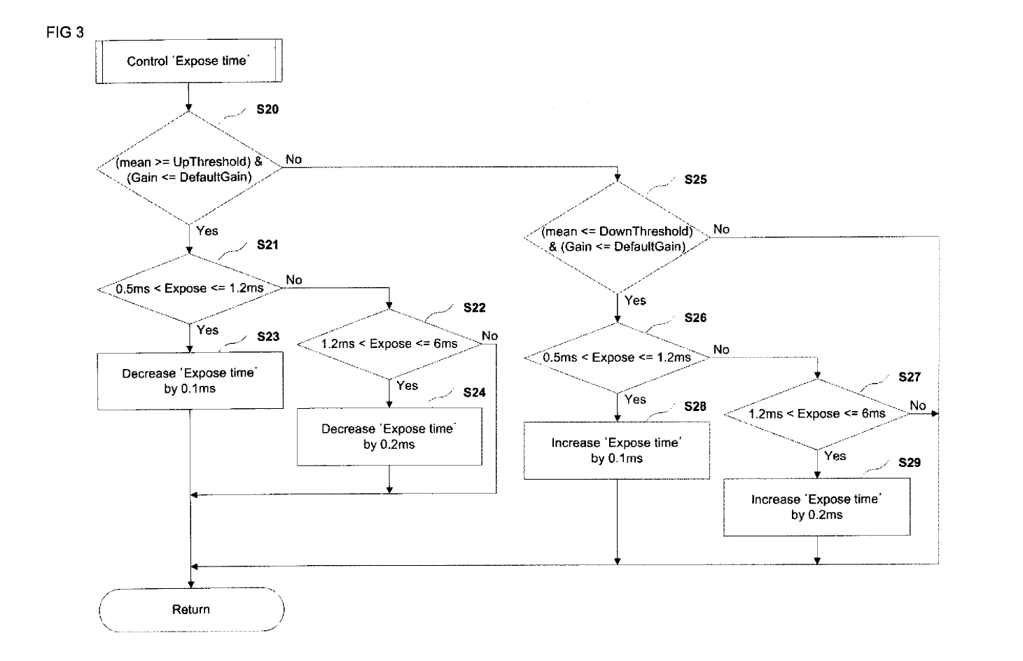

FIG. 3 is the flow chart of controlling a camera with its exposure time parameter. FIG. 3 is the detailed control flow chart of S16 stage of FIG. 2. Firstly, the system calculates the average brightness of the current image frame. After getting an average brightness value, the system compares the brightness value with UpThreshold (S20). If the average brightness value is bigger than UpThreshold, the system checks out the current set exposure time (S21, S22). If the exposure time is set between 0.5 ms and 1.2 ms, the system decreases exposure time by 0.1 ms for each frame (S23). If the exposure time is set between 1.2 ms and 6.0 ms, the system decreases exposure time by 0.2 ms for each frame (S24). If the average brightness value is smaller than UpThreshold, the system compares average brightness value with DownThreshold. If the average brightness value is smaller than DownThreshold, the system checks out the current set exposure time (S26, S27). If the exposure time is set between 0.5 ms and 1.2 ms, the system increases exposure time by 0.1 ms for each frame (S28). If the exposure time is set between 1.2 ms and 6.0 ms, the system increases exposure time by 0.2 ms for each frame (S29).

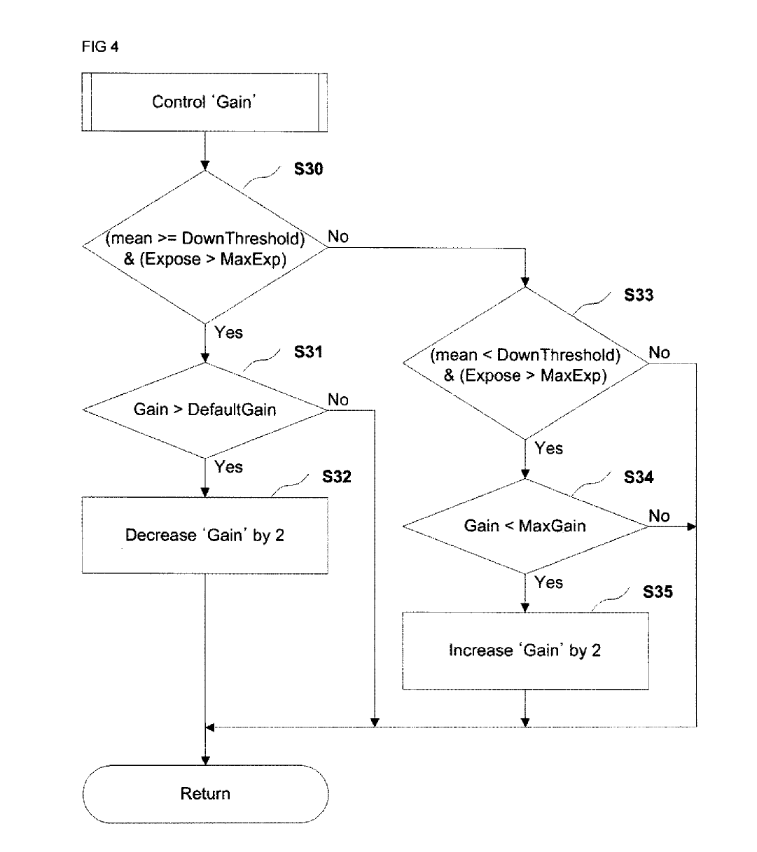

FIG. 4 is the flow chart of controlling a camera with its gain level parameter. The gain level parameter is adjusted only when the exposure time reaches to MaxExp parameter. At S30 stage, system compares the current average brightness value with DownThreshold. If the average brightness value is bigger than DownThreshold, the system decreases gain level by 2 until it approaches to DefaultGain parameter (S31, S32). If the average brightness value is smaller than DownThreshold, the system increases gain level by 2 until it approaches to MaxGain parameter (S34, S35).

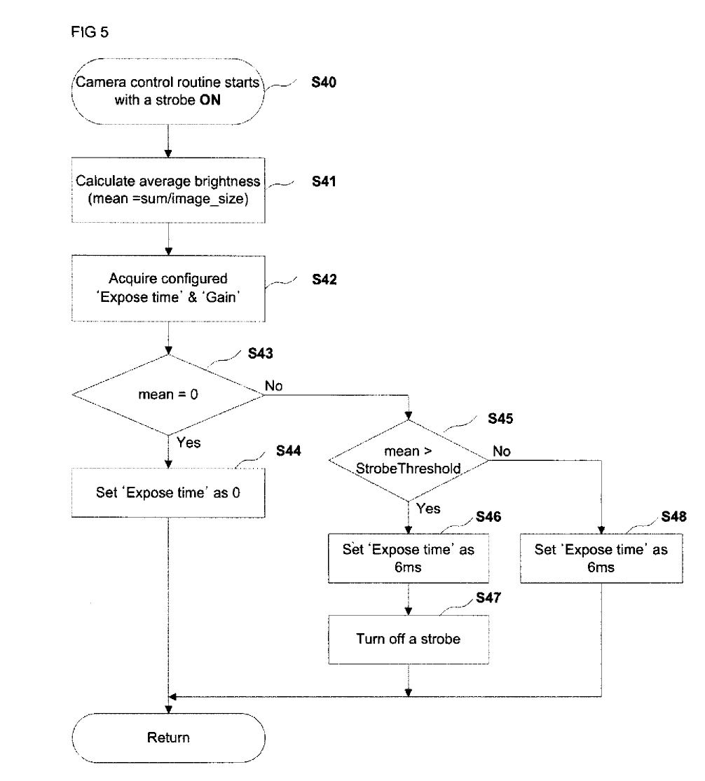

FIG. 5 is the flow chart of controlling ca camera during night time. When a strobe is on, the system calculates an average brightness of the current image frame and gets exposure time and gain level from a camera (S40, 41, 42). If the average brightness is ‘0’, the surroundings are very dark. In the case, the system fixes exposure time to avoid side effect by reflection of a strobe. The fixed exposure time is 3 ms, which maintains as long as the average brightness is ‘0’ (S43, S44). If the average brightness is bigger than ‘0’, the system sets exposure time as ‘MaxExp (6 ms) and compares the brightness value with StrobeThreshold to decide whether turn off a strobe or not (S45, S46, S48). If the average brightness is bigger than StrobeThreshold, the system turns off a strobe (S47). Otherwise, they system waits for next image frame.

This development shall be used in license plate recognition module of vehicle entrance control system in an apartment complex or building.

1. A camera control method for a vehicle entrance control system comprising the steps of:
a) calculating an average value of image brightness and writing multiple parameters of exposure time and gain level that match with a calculated average brightness value in a lookup table to a camera control register;
b) comparing the average brightness value with a threshold of strobe operation and comparing acquired exposure time and gain level parameters with preset maximum limitations;
c) turning on a strobe if the acquired exposure time and gain level parameters are higher than the preset maximum limitation and the average brightness value is lower than the strobe operation threshold; and
d) adjusting the exposure time and gain level if the acquired exposure time and gain level parameters are lower than the preset maximum limitation and the average brightness value is higher than the strobe operation threshold.

2. The control method of claim 1 wherein an exposure time may be fixed as a certain value in controlling shutter speed and adjusting gain level between maximum and minimum values while the strobe is on.

3. The control method of claim 1 wherein step (d) comprises adjusting the exposure time first and then adjusting the gain level when the exposure time value reaches to the maximum value.

4. The control method of claim 1 wherein step (d) comprises increasing or decreasing the exposure time by a certain preset unit.

5. The control method of claim 1 wherein step (d) comprises increasing or decreasing the gain level by a certain preset unit.

6. A method of controlling a camera for a recognition system, comprising:
calculating an average brightness of a reference image captured by the camera, the camera having a plurality of operational parameter values;
retrieving from the camera the operational parameter values corresponding to the captured reference image, including a reference exposure time value and a reference gain level value; and
generating an improved second image based upon a comparison of the average brightness, the reference exposure time value, and the reference gain level value relative to predefined threshold values of the respective ones of brightness, exposure time, and gain, the operational parameter values being adjusted in response thereto for the capture of the second image.

7. The method of claim 6, wherein the step of generating the improved second image includes adjusting the brightness thereof at a subsequent capture after that of the reference image.

8. The method of claim 7, wherein:
the reference exposure time value and the reference gain level value are within the predefined threshold values for the respective one of the exposure time and gain; and
the step of adjusting the brightness of the improved second image includes modifying the exposure time operational parameter value.

9. The method of claim 8, wherein the average brightness of the reference image is higher than a first threshold, the method including the step of the reducing the exposure time operational parameter value.

10. The method of claim 8, wherein the average brightness of the reference image is lower than a first threshold, the method including the step of increasing the exposure time operational parameter value.

11. the method of claim 8, wherein modifying the exposure time operational parameter value is by two different modification amounts according to two ranges of the reference exposure time value.

12. The method of claim 11, wherein:
a first one of the two ranges of the exposure time is between 0.5 ms and 1.2 ms, and a second of the two ranges of the exposure time is between 1.2 ms and 6 ms; and
the first modification amount corresponding to the first one of the two ranges is 0.1 ms and the second modification amount corresponding to the second one of the two ranges is 0.2 ms.

13. The method of claim 7, wherein:
the reference exposure time value exceeds the predefined threshold value of the exposure time, and the reference gain value is within the predefined threshold value of the gain; and
the step of adjusting the brightness of the improved second image includes modifying the gain operational parameter value.

14. The method of claim 13, wherein the average brightness of the reference image is higher than a first threshold, the method including the step of the reducing the gain operational parameter value.

15. The method of claim 13, wherein the average brightness of the reference image is lower than a first threshold, the method including the step of increasing the gain operational parameter value.

16. the method of claim 13, wherein the gain is modified by a factor of two.

17. The method of claim 7, wherein:
the reference exposure time value and the reference gain level value exceed the predefined threshold values for the respective one of the exposure time and gain;
the average brightness of the reference image exceeds the predefined threshold value for brightness; and
the step of adjusting the brightness of the improved second image includes activating a strobe.

18. The method of claim 6, further comprising:
transmitting the improved second image to the recognition system.
